(19) United States
(12) Patent Application Publication
(10) Pub. No.: US 2023/0122162 A1
(43) Pub. Date: Apr. 20, 2023

(54) System and Method for Molding Plastic Composite Material Panel

(71) Applicants: Hyundai Motor Company, Seoul (KR); Kia Corporation, Seoul (KR)

(72) Inventors: Minsoo Kim, Suwon-si (KR); Hyuncheol Yun, Seoul (KR); Sang Sun Park, Anyang-si (KR); Woojin Kim, Seongnam-si (KR); Hyunyi Kwon, Ulsan (KR)

(21) Appl. No.: 17/565,970

(22) Filed: Dec. 30, 2021

(30) Foreign Application Priority Data
Oct. 19, 2021 (KR) 10-2021-0139288

(51) Int. Cl. B29C 70/34; B29C 70/54; B29C 48/07; B29C 48/21; B29C 48/00

(52) U.S. Cl. CPC B29C 70/345; B29C 70/545; B29C 48/07; B29C 48/21; B29C 48/022; B29C 2793/0027; B29K 2033/12

(57) ABSTRACT

An embodiment system for molding a plurality of plastic composite material panels to be assembled on a vehicle body includes a coextrusion unit configured to manufacture a multi-layered sheet in which a plurality of resin layers are laminated, a thermoforming unit configured to manufacture a forming sheet having a plurality of panel forming portions partitioned by a forming connection portion by thermoforming the multi-layered sheet, a reinforcing source spraying unit configured to spray a reinforcing source in which a fiber material and a polyurethane compound are mixed toward a preset region on the forming sheet, and a press-molding unit configured to press-mold the forming sheet applied with the reinforcing source to manufacture a composite material panel sheet in which a reinforcing layer is formed on the forming sheet.

### CROSS-REFERENCE TO RELATED APPLICATIONS

This application claims the benefit of Korean Patent Application No. 10-2021-0139288, filed on Oct. 19, 2021, which application is hereby incorporated herein by reference.

### TECHNICAL FIELD

The present disclosure relates to a system and method for molding plastic composite material panels.

### BACKGROUND

Recently, the vehicle industry has introduced a new concept of future mobility vision for realizing a dynamic human-centered future city. One of these future mobility solutions is a purpose-built vehicle (PBV) as a purpose-based mobility.

The PBV is an environment-friendly vehicle that provides a customized service for passengers during a period in which they travel to their destination, and is typically electric vehicle-based. A vehicle body of the PBV includes an underbody (which is frequently called a rolling chassis or a skateboard) and an upper body mounted on the underbody.

Here, the upper body includes a vehicle body frame and a plurality of outer panels assembled to the vehicle body frame. In an example, steel material panels that are press-molded by a press mold are typically used as the outer panels.

In order to form the outer panels made of such a steel material, a press mold corresponding to each of the outer panels needs to be developed. However, the development period of the press mold is long, and an excessive development cost is thereby caused. Furthermore, a painting process for painting the outer panels made of press-molded steel is also required.

Accordingly, a molding technology of plastic composite material panels is being introduced, which is advantageous for the small-volume production of outer panels, makes it possible to reduce the weight of the vehicle, and does not require painting.

However, molding facilities for molding a plastic composite panel applied to each of the outer panels are required. In addition, in comparison with the steel material panel, the outer panels formed as the plastic composite material panel have disadvantages in that they lack rigidity and are vulnerable to thermal deformation.

The above information disclosed in this Background section is only for enhancement of understanding of the background of the disclosure, and therefore it may contain information that does not form the prior art that is already known to a person of ordinary skill in the art.

### SUMMARY

Embodiments of the present disclosure provide a system for molding plastic composite material panels capable of forming a plurality of plastic composite material panels without requiring painting by simultaneously molding various panel parts from a single sheet of material.

An embodiment system for molding a plurality of plastic composite material panels to be assembled on a vehicle body includes a coextrusion unit configured to manufacture a multi-layered sheet in which a plurality of resin layers are laminated, a thermoforming unit configured to manufacture a forming sheet having a plurality of panel forming portions partitioned by a forming connection portion by thermoforming the multi-layered sheet, a reinforcing source spraying unit configured to spray a reinforcing source in which a fiber material and a polyurethane compound are mixed toward a preset region on the forming sheet, and a press-molding unit configured to press-mold the forming sheet applied with the reinforcing source to manufacture a composite material panel sheet in which a reinforcing layer is formed on the forming sheet.

An embodiment system for molding a plurality of plastic composite material panels may further include a trimming unit configured to cut the forming connection portion in the composite material panel sheet.

A plurality of cut parts remaining by cutting of the forming connection portion from the composite material panel sheet may be provided as the plurality of plastic composite material panels.

An embodiment system for molding a plurality of plastic composite material panels may further include a reinforcing source mixing unit configured to mix the reinforcing source including polyol, isocyanate, and the fiber material.

The fiber material may include at least one fiber of carbon fiber, glass fiber and aramid fiber.

The multi-layered sheet may include a first resin layer including polymethyl methacrylate (PMMA) resin, a second resin layer including at least one resin of acrylonitrile butadiene styrene (ABS), polycarbonate (PC) and acrylate styrene acrylonitrile (ASA) resin, and a third resin layer including an acrylic resin that may be coated on the first resin layer.

The coextrusion unit may include a plurality of extrusion portions configured to extrude the plurality of resin layers, and a combining adaptor configured to laminate the plurality of resin layers extruded from the plurality of extrusion portions.

The thermoforming unit may include a forming die provided on a frame to be vertically movable and having a plurality of forming sections partitioned by a connection section in a groove shape, and a forming tool provided on the frame to be vertically movable to pressurize the multi-layered sheet toward the connection section.

The thermoforming unit may further include an air spraying portion configured to spray air to the multi-layered sheet having an edge portion fixed to the frame.

The forming tool may include a forming block in a trapezoidal shape that may be inserted into the connection section.

The reinforcing source spraying unit may include a reinforcing source spraying head mounted on an arm of a handling robot and configured to spray the reinforcing source toward the forming sheet loaded on the press-molding unit.

The reinforcing source spraying head may be configured to spray the reinforcing source on an entire region of an upper surface of the forming sheet by a robot operation of the handling robot.

The reinforcing source spraying head may be configured to spray the reinforcing source on at least one panel forming portion excluding at least one remaining panel forming portion of the forming sheet by a robot operation of the handling robot.

The press-molding unit may include a lower die including a forming protrusion portion to be fitted into the forming connection portion in a lower portion of the forming sheet, and an upper die installed to be vertically movable relatively to the lower die, and including a forming groove portion into which the forming connection portion in an upper portion of the forming sheet is to be fitted.

The trimming unit may include a trimming cutter configured to cut a part of the forming connection portion.

According to embodiments of the present disclosure, it is possible to reduce the investment cost for the molds and the manufacturing cost to mold a plurality of plastic composite panels to be assembled in the vehicle body, and to reduce the production cycle time.

Other effects that may be obtained or are predicted by an embodiment will be explicitly or implicitly described in a detailed description of the present disclosure. That is, various effects that are predicted according to an embodiment will be described in the following detailed description.

### BRIEF DESCRIPTION OF THE DRAWINGS

The drawings are intended to be used as references for describing the embodiments of the present disclosure, and the accompanying drawings should not be construed as limiting the technical spirit of the present disclosure.

FIG. 1 is a process diagram schematically illustrating a system for molding plastic composite material panels according to an embodiment.

FIG. 2 schematically illustrates an exemplary application of a plastic composite material panel formed by a system for molding plastic composite material panels according to an embodiment.

FIG. 3 schematically illustrates a coextrusion unit applied to a system for molding plastic composite material panels according to an embodiment.

FIG. 4 schematically illustrates a forming sheet formed by a thermoforming unit applied to a system for molding plastic composite material panels according to an embodiment.

FIG. 5 schematically illustrates a thermoforming unit applied to a system for molding plastic composite material panels according to an embodiment.

FIG. 6 schematically illustrates a reinforcing source mixing unit applied to a system for molding plastic composite material panels according to an embodiment.

FIG. 7 schematically illustrates a reinforcing source spraying unit applied to a system for molding plastic composite material panels according to an embodiment.

FIG. 8 schematically illustrates a composite material panel sheet formed by a press-molding unit applied to a system for molding plastic composite material panels according to an embodiment.

FIG. 9 schematically illustrates a press-molding unit applied to a system for molding plastic composite material panels according to an embodiment.

FIG. 10 schematically illustrates a trimming unit applied to a system for molding plastic composite material panels according to an embodiment.

FIG. 11 schematically illustrates a plastic composite material panel manufactured by a system for molding plastic composite material panels according to an embodiment.

FIG. 12 is a flowchart schematically illustrating a method for molding plastic composite material panels by using a system for molding plastic composite material panels according to an embodiment.

FIGS. 13A and 13B schematically illustrate a comparison example for explaining an operation of a system for molding plastic composite material panels according to an embodiment.

FIG. 14 schematically illustrates another example of a method for molding plastic composite material panels by using a system for molding plastic composite material panels according to an embodiment.

FIG. 15 schematically illustrates a plastic composite material panel formed by another example of a method for molding plastic composite material panels by using a system for molding plastic composite material panels according to an embodiment.

It should be understood that the above-referenced drawings are not necessarily to scale, presenting a somewhat simplified representation of various preferred features illustrative of the basic principles of the disclosure. The specific design features of embodiments of the present disclosure, including, for example, specific dimensions, orientations, locations, and shapes, will be determined in part by the particular intended application and use environment.

The following elements may be used in connection with the drawings to describe embodiments of the present disclosure.

| | |
|---|---|
| 1: upper body | 3: vehicle body frame |
| 5: outer panel | |
| 10, 110: plastic composite material | |
| panel | |
| 11: plate portion | 13: parting portion |
| 20: coextrusion unit | 21: multi-layered sheet |
| 22: first resin layer | 23: second resin layer |
| 24: third resin layer | 25: extrusion portion |
| 27: combining adaptor | 30: thermoforming unit |
| 31: forming sheet | 33, 133: forming connection |
| | portion |
| 35, 135: panel forming portion | 37, 137: connection region |
| 41: frame | 42: forming die |
| 43: forming tool | 44: air spraying portion |
| 45, 145: connection section | 46: forming section |
| 47: forming block | 50: reinforcing source mixing unit |
| 51: reinforcing source | 52: fiber material |
| 53: polyurethane compound | 54: mixing main body |
| 55: first inlet portion | 56: second inlet portion |
| 57: discharge portion | 60: reinforcing source spraying |
| | unit |
| 61: transfer line | 63: handling robot |
| 65: reinforcing source spraying head | 67: pump |
| 70: press-molding unit | 71: reinforcing layer |
| 73: composite material panel sheet | 73a: cut part |
| 75: lower die | 76: forming protrusion portion |
| 77: upper die | 78: forming groove portion |
| 80: trimming unit | 81: trimming cutter |
| 100: a system for molding plastic | |
| composite material panels | |
| 101: wire | |

### DETAILED DESCRIPTION OF ILLUSTRATIVE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

The terminology used herein is for the purpose of describing particular embodiments only and is not intended to be limiting of the present disclosure. As used herein, the singular forms are intended to include the plural forms as well, unless the context clearly indicates otherwise.

As used herein, the term “comprises” and/or “comprising” refers to the presence of specified features, integers, steps, acts, elements and/or components, but it should also be understood that it does not exclude a presence or an addition of one or more other features, integers, steps, acts, elements, components, and/or groups thereof. As used herein, the term “and/or” includes any one or all combinations of one or more related items. The term “coupled” denotes a physical relationship between two components in which components are directly connected to each other or indirectly through one or more intermediary components, for example, by welding, self-piercing rivet (SPR), flow drill screw (FDS), structural adhesives, and the like.

The terms “vehicle”, “of a vehicle”, “automobile” or other similar terms used herein are generally used to cover various vehicles such as passenger vehicles including sports cars, sport utility vehicles (SUVs), buses, trucks, commercial vehicles, and the like, and cover hybrid vehicles, electric vehicles, hybrid electric vehicles, fuel cell electric vehicles, and other alternative fuel vehicles (i.e., vehicles driven by a fuel derived from resources other than petroleum).

Hereinafter, embodiments of the present disclosure are described in detail with reference to the accompanying drawings.

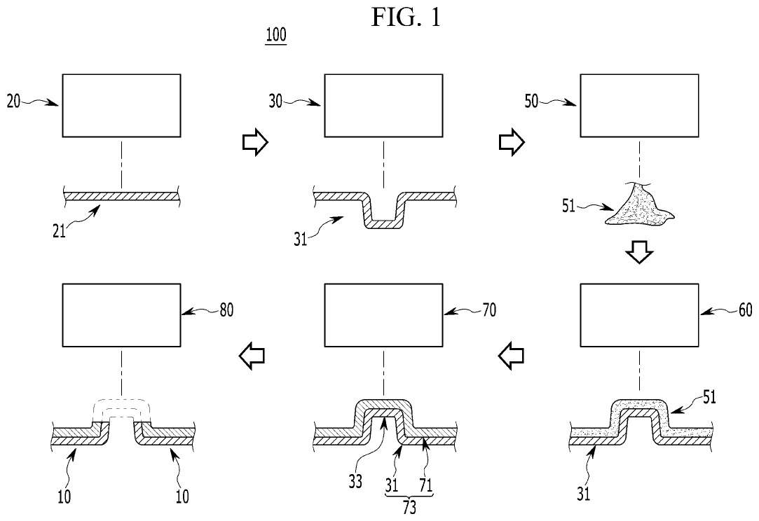

FIG. 1 is a process diagram schematically illustrating a system for molding plastic composite material panels according to an embodiment.

Referring to FIG. 1, a system 100 for molding plastic composite material panels according to an embodiment may be applied to a process of manufacturing a plurality of vehicle body component parts to be assembled to a vehicle body.

In an example, a system 100 for molding plastic composite material panels according to an embodiment may be applied to a process of manufacturing a plurality of vehicle body component parts to be assembled to a vehicle body of a PBV that is manufactured in a relatively small volume.

Here, the PBV may be defined as an environment-friendly vehicle that is electric vehicle-based and provides a customized service for passengers while traveling to a destination.

In an example, the vehicle body of the PBV may include an underbody (frequently called a “rolling chassis” or “skateboard” in the art) and an upper body mounted on the underbody.

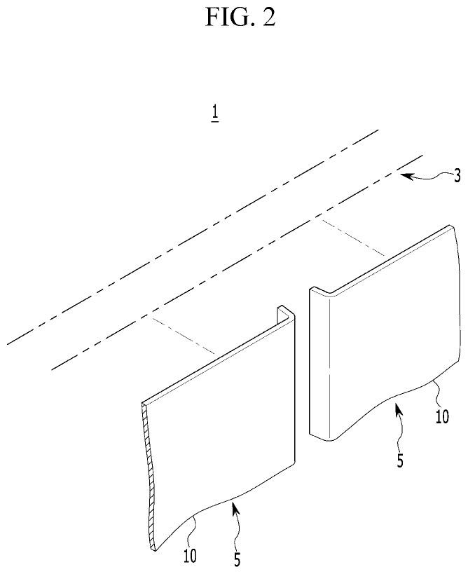

As shown in FIG. 2, the system 100 for molding plastic composite material panels according to an embodiment may be applied to a process of manufacturing a plurality of outer panels 5 to be assembled on respective preset locations of a vehicle body frame 3 in an upper body 1 of the PBV.

Here, the plurality of outer panels 5 may include at least one side outer panel, at least one fender outer panel, at least one door outer panel, and at least one tailgate outer panel.

Furthermore, the system 100 for molding plastic composite material panels according to an embodiment is configured to form a plurality of plastic composite material panels 10 that may be applied as the plurality of outer panels 5.

In this specification, “upper end portion”, “upper portion”, “upper end”, or “upper portion surface” of a component indicates an end portion, portion, end, or surface of the component that is relatively positioned higher in the drawing, and “lower end portion”, “lower portion”, “lower end”, or “lower portion surface” of a component indicates an end portion, portion, end, or surface of the component that is relatively positioned lower in the drawing.

In addition, in this specification, “end” (for example, one end, another end, or the like) of a component indicates an end of the component in any direction, and “end portion” (for example, one end portion, another end portion, or the like) of a component indicates a certain part of the component including the end.

Referring to FIG. 1 and FIG. 2, the system 100 for molding plastic composite material panels according to an embodiment is configured in a structure capable of simultaneously molding a plurality of plastic composite material panels 10 that do not require painting and provide good panel quality and strengthened rigidity.

For such a purpose, the system 100 for molding plastic composite material panels according to an embodiment includes a coextrusion unit 20, a thermoforming unit 30, a reinforcing source mixing unit 50, a reinforcing source spraying unit 60, a press-molding unit 70, and a trimming unit 80.

In an embodiment, the coextrusion unit 20 is configured to manufacture a multi-layered sheet 21.

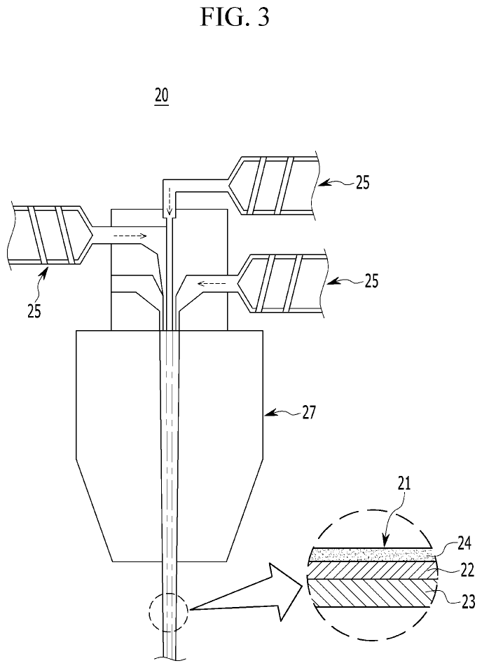

FIG. 3 schematically illustrates a coextrusion unit applied to a system for molding plastic composite material panels according to an embodiment.

Referring to FIG. 1 and FIG. 3, the coextrusion unit 20 according to an embodiment may manufacture the multi-layered sheet 21 in which a plurality of resin layers 22, 23, and 24 are laminated.

In an example, the plurality of resin layers 22, 23, and 24 includes a first resin layer 22, a second resin layer 23, and a third resin layer 24.

The first resin layer 22 may include polymethyl methacrylate (PMMA) resin.

The second resin layer 23 may include at least one resin of acrylonitrile butadiene styrene (ABS), polycarbonate (PC) and acrylate styrene acrylonitrile (ASA) resin.

In addition, the third resin layer 24 may include an acrylic resin that may be coated on the first resin layer 22. The third resin layer 24 may be formed as a hard coating layer (frequently called a “clear coat layer” in the art) coated on the first resin layer 22.

Here, the first resin layer 22 and the second resin layer 23 may have a preset color, and the third resin layer 24 may be a transparent hard coating layer.

Furthermore, with reference to the drawings, the third resin layer 24 is laminated on an upper surface of the first resin layer 22, and the second resin layer 23 is laminated on a lower surface of the first resin layer 22.

However, the present disclosure is not necessarily limited thereto, and the technical idea of the present disclosure may be applied as long as it is a multi-layered sheet in which layers of various resins are laminated.

The coextrusion unit 20 configured to manufacture the multi-layered sheet 21 includes a plurality of extrusion portions 25 and a combining adaptor 27.

The plurality of extrusion portions 25 is configured to simultaneously extrude the first resin layer 22, the second resin layer 23, and the third resin layer 24. In an example, each of the plurality of extrusion portions 25 may extrude a molten resin by a screw transfer method that is well-known in the art.

The combining adaptor 27 is configured to laminate, in a molten state, the first resin layer 22, the second resin layer 23, and the third resin layer 24 that are simultaneously extruded from the plurality of extrusion portions 25.

Referring to FIG. 1, in an embodiment, the thermoforming unit 30 is configured to manufacture a forming sheet 31 formed by forming the multi-layered sheet 21 manufactured by the coextrusion unit 20 into a preset shape through a thermoforming process.

Here, the thermoforming process may be defined as a process of forming the multi-layered sheet 21, separately preheated in a heating chamber well known in the art, into a set shape.

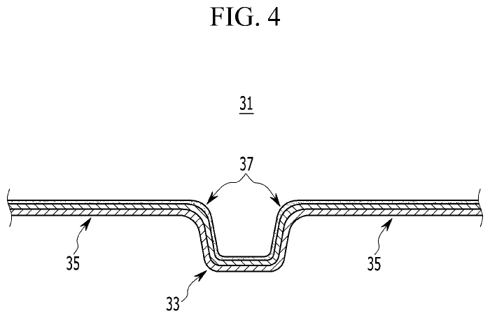

As shown in FIG. 4, the forming sheet 31 includes a plurality of panel forming portions 35 integrally connected to each other by a forming connection portion 33 of a preset shape.

The plurality of panel forming portions 35 are molded in shapes corresponding to the plurality of plastic composite material panels 10 (refer to FIG. 2) described above. The plurality of panel forming portions 35 are partitioned by the forming connection portion 33.

The forming connection portion 33 is provided in a forming shape concavely curved from top to bottom between the plurality of panel forming portions 35, and is integrally connected to the plurality of panel forming portions 35.

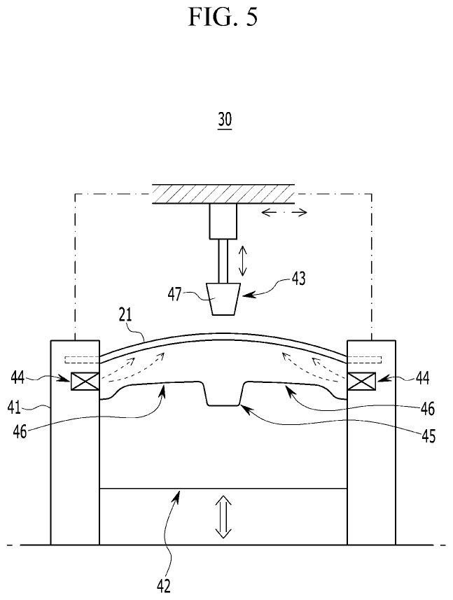

FIG. 5 schematically illustrates a thermoforming unit applied to a system for molding plastic composite material panels according to an embodiment.

Referring to FIG. 4 and FIG. 5, the thermoforming unit 30 configured to manufacture the forming sheet 31 includes a frame 41, a forming die 42, a forming tool 43, and an air spraying portion 44.

The frame 41 is installed on a floor surface where the thermoforming process is performed. The forming die 42 is provided as a lower die that supports the multi-layered sheet 21. The forming die 42 is provided on the frame 41 to be vertically movable. Here, the forming die 42 may vertically move by an operation of a hydraulic cylinder (not shown) well-known in the art.

The forming die 42 includes a plurality of forming sections 46 partitioned by a connection section 45. The connection section 45 is configured to form the forming connection portion 33 of the forming sheet 31.

The connection section 45 is formed in a groove shape on an upper surface of the forming die 42. In one example, the connection section 45 has a shape corresponding to the forming connection portion 33, and may be formed as a trapezoidal groove shape having a large top area and a narrow bottom area.

The plurality of forming sections 46 is configured to form the plurality of panel forming portions 35 of the forming sheet 31. The connection section 45 is interposed between the plurality of forming sections 46, and each of the plurality of forming sections 46 is connected to the connection section 45.

The forming tool 43 (frequently called “forming helper” in the art) is configured to substantially form the forming connection portion 33 and the plurality of panel forming portions 35 of the forming sheet 31.

The forming tool 43 is installed on the frame 41 to be vertically movable to pressurize the multi-layered sheet 21 placed on the forming die 42 toward the connection section 45. The forming tool 43 may form the forming connection portion 33 of the forming sheet 31 by the connection section 45, and may form the plurality of panel forming portions 35 of the forming sheet 31 by the plurality of forming sections 46.

In an example, the forming tool 43 is configured to press the multi-layered sheet 21, and may include a forming block 47 in a trapezoid cross-section shape having a lower area relatively smaller than an upper area to be inserted into the connection section 45.

The forming tool 43 described above may vertically move by an operation of a hydraulic cylinder or a pneumatic cylinder (not shown) well-known in the art (refer to the vertical arrow shown in the drawing). In addition, the forming tool 43 may move in a horizontal direction (shown in horizontal arrows in the drawing) perpendicular to a vertical direction depending on the specification of the forming sheet 31 to be molded, by an operation of a hydraulic cylinder or a pneumatic cylinder (not shown).

The air spraying portion 44 is configured to spray air to the multi-layered sheet 21 having been preheated and having an edge portion fixed to the frame 41. The air spraying portion 44 is installed on the frame 41.

Since the multi-layered sheet 21 is preheated, as the air spraying portion 44 sprays air, the multi-layered sheet 21 may be bulged upward by the pressure of the air.

Here, the forming die 42 may move upward while the multi-layered sheet 21 is bulged upward by the pressure of the air sprayed by the air spraying portion 44.

In addition, while the forming die 42 moves upward, the forming tool 43 may move downward to pressurize the multi-layered sheet 21 toward the connection section 45 of the forming die 42.

Referring back to FIG. 1, in an embodiment, the reinforcing source mixing unit 50 is configured to mix a reinforcing source 51 that is applicable to the forming sheet 31 formed by the thermoforming unit 30.

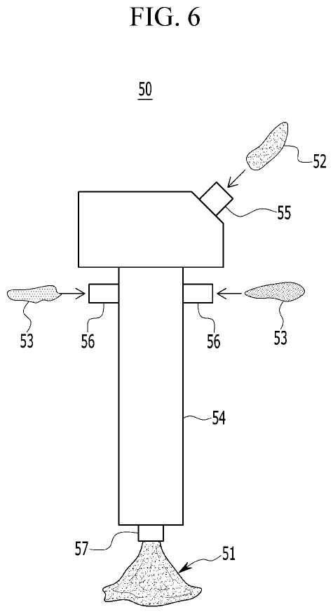

FIG. 6 schematically illustrates a reinforcing source mixing unit applied to a system for molding plastic composite material panels according to an embodiment.

Referring to FIG. 1 and FIG. 6, the reinforcing source mixing unit 50 according to an embodiment is configured to mix the reinforcing source 51 including a fiber material 52 and a polyurethane compound 53.

Here, the fiber material 52 may include at least one fiber of carbon fiber, glass fiber and aramid fiber.

In addition, the polyurethane compound 53 may include polyol and isocyanate.

The reinforcing source mixing unit 50 configured to mix the reinforcing source 51 includes a mixing main body 54, a first inlet portion 55, a pair of second inlet portions 56, and a discharge portion 57.

A mixing device (not shown) well-known in the art is installed in an interior of the mixing main body 54. The first inlet portion 55 is configured to receive the fiber material 52 into the interior of the mixing main body 54. The pair of second inlet portions 56 are configured to receive each of the polyurethane compound 53 into the interior of the mixing main body 54.

One of the pair of second inlet portions 56 is configured to receive the polyol into the interior of the mixing main body 54, and the other one is configured to receive the isocyanate into the interior of the mixing main body 54.

In addition, the discharge portion 57 is configured to discharge the reinforcing source 51 of the fiber material 52 and the polyurethane compound 53 that are mixed by the mixing device in the interior of the mixing main body 54.

Here, the reinforcing source 51 includes polyurethane material generated by a reaction of polyol and isocyanate. The reinforcing source 51 is discharged through the discharge portion 57 in the form of a gel, and may be transferred by a screw transfer method well-known in the art.

Referring to FIG. 1, in an embodiment, the reinforcing source spraying unit 60 is configured to spray the reinforcing source 51 toward a preset region of an upper surface of the forming sheet 31 formed by the thermoforming unit 30.

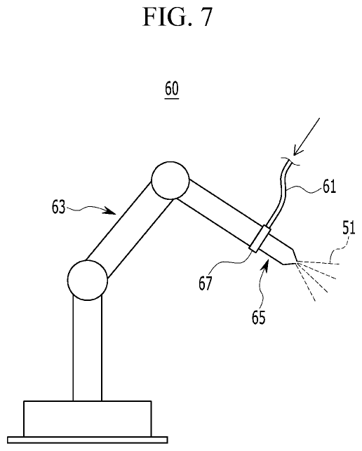

The reinforcing source spraying unit 60 may spray the reinforcing source 51 transferred from the reinforcing source mixing unit 50 through a transfer line 61 (refer to FIG. 7), by a preset pumping pressure.

FIG. 7 schematically illustrates a reinforcing source spraying unit applied to a system for molding plastic composite material panels according to an embodiment.

Referring to FIG. 1 and FIG. 7, the reinforcing source spraying unit 60 according to an embodiment includes a reinforcing source spraying head 65 mounted on an arm of a handling robot 63.

The reinforcing source spraying head 65 is configured to spray the reinforcing source 51 transferred through the transfer line 61, by an operation of a pump 67.

Here, the handling robot 63 may be a multi-joint robot well-known in the art. The reinforcing source spraying head 65 may spray the reinforcing source 51 toward the upper surface of the forming sheet 31 loaded on the press-molding unit 70. Furthermore, by a robot operation of the handling robot 63, the reinforcing source spraying head 65 may spray the reinforcing source 51 to an entire region of the upper surface of the forming sheet 31.

Referring to FIG. 1, in an embodiment, the press-molding unit 70 is configured to press-mold the forming sheet 31 applied with the reinforcing source 51.

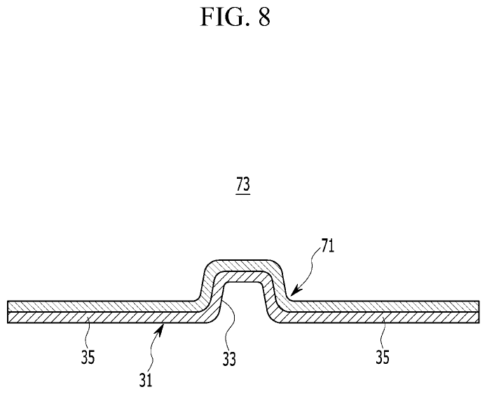

The press-molding unit 70 is configured to manufacture a composite material panel sheet 73 in which a reinforcing layer 71 of the reinforcing source 51 is formed on the forming sheet 31, as shown in FIG. 8. The reinforcing layer 71 may strengthen the rigidity of the forming sheet 31, and may minimize thermal deformation thereof.

With reference to the drawing, the reinforcing layer 71 in the composite material panel sheet 73 is formed on the entire region of the upper surface of the forming sheet 31. That is, the reinforcing layer 71 is entirely formed on upper surfaces of the forming connection portion 33 and the plurality of panel forming portions 35 of the forming sheet 31.

Here, the upper surface of the forming sheet 31 refers to the second resin layer 23 described above, and a lower surface of the forming sheet 31 refers to the third resin layer 24 described above (refer to FIG. 3).

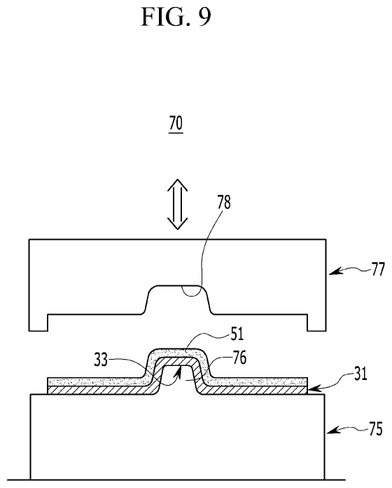

FIG. 9 schematically illustrates a press-molding unit applied to a system for molding plastic composite material panels according to an embodiment.

Referring to FIG. 8 and FIG. 9, the press-molding unit 70 configured to manufacture the composite material panel sheet 73 includes a lower die 75 and an upper die 77.

The lower die 75 is installed on a floor surface of the press-molding process. The lower die 75 includes a forming protrusion portion 76 provided on an upper surface (frequently called a “lower steel” in the art) of the die. The forming protrusion portion 76 may be fitted into the forming connection portion 33 in the lower portion (lower surface) of the forming sheet 31.

The upper die 77 is installed to be vertically movable relative to the lower die 75. The upper die 77 may vertically move by an operation of a hydraulic cylinder well-known in the art.

The upper die 77 includes a forming groove portion 78 provided on a lower surface (frequently called an “upper steel” in the art) of the die. The forming connection portion 33 in an upper portion (upper surface) of the forming sheet 31 may be fitted into the forming groove portion 78, and thereby the forming groove portion 78 may be coupled with forming connection portion 33.

Here, the forming sheet 31 is loaded on an upper surface of the lower die 75, and the reinforcing source 51 sprayed by the reinforcing source spraying unit 60 (refer to FIG. 7) may be applied on the entire region of the upper surface of the forming sheet 31. In addition, as the upper die 77 is combined with the lower die 75, the composite material panel sheet 73 in which the reinforcing layer 71 is formed on the upper surface of the forming sheet 31 is molded.

Referring to FIG. 1, in an embodiment, the trimming unit 80 is configured to cut the forming connection portion 33 in the composite material panel sheet 73 manufactured by the press-molding unit 70.

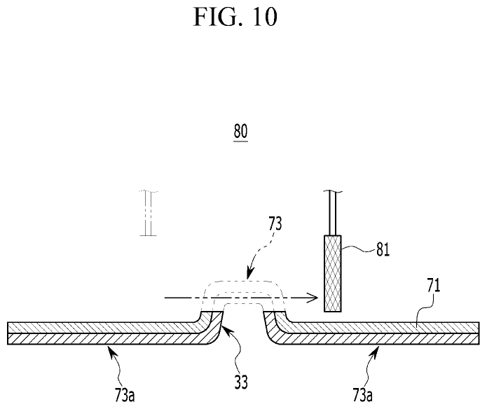

FIG. 10 schematically illustrates a trimming unit applied to a system for molding plastic composite material panels according to an embodiment.

Referring to FIG. 10, the trimming unit 80 according to an embodiment includes a trimming cutter 81 configured to cut a part of the forming connection portion 33 (shown in the double-dot chain line in the drawing) in which the reinforcing layer 71 is formed.

In an example, the trimming cutter 81 may be provided as a drill type cutter well-known in the art. The trimming cutter 81 may cut the part of the forming connection portion 33 while moving along the forming connection portion 33.

As the part of the forming connection portion 33 is cut from the composite material panel sheet 73 by the trimming unit 80, the composite material panel sheet 73 is divided into a plurality of cut parts 73a.

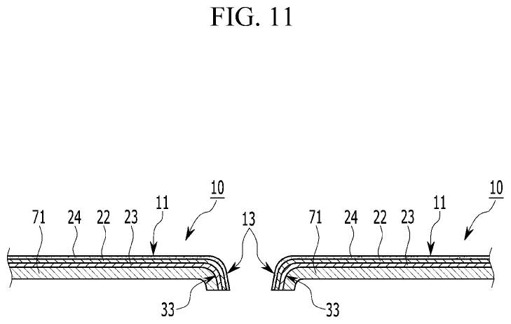

Here, the plurality of cut parts 73a are remaining parts of the composite material panel sheet 73 except for the part of the forming connection portion 33. The plurality of cut parts 73a remaining after the cutting may be provided as the plurality of plastic composite material panels 10 as shown in FIG. 11.

It may be understood that the plurality of plastic composite material panels 10 may be adjacent panels to be assembled to the vehicle body, and a parting gap between the adjacent panels may become sufficiently small and be uniform by the simultaneous forming.

Each of the plurality of plastic composite material panels 10 may be provided as a panel of a preset color in which the third resin layer 24, the first resin layer 22, the second resin layer 23, and the reinforcing layer 71 are sequentially laminated with reference to skin surfaces.

Furthermore, as shown in FIG. 11, each of the plurality of plastic composite material panels 10 includes a plate portion 11 and a parting portion 13 integrally connected to the plate portion 11.

The plate portion 11 forms a panel surface of the plurality of plastic composite material panels 10. The parting portion 13 is a remaining portion of the forming connection portion 33 (refer to FIG. 10), and extends curvedly in a round shape from the plate portion 11.

Hereinafter, a method for molding plastic composite material panels by using the system 100 for molding plastic composite material panels according to an embodiment is described in detail with reference to FIG. 1 to FIG. 15.

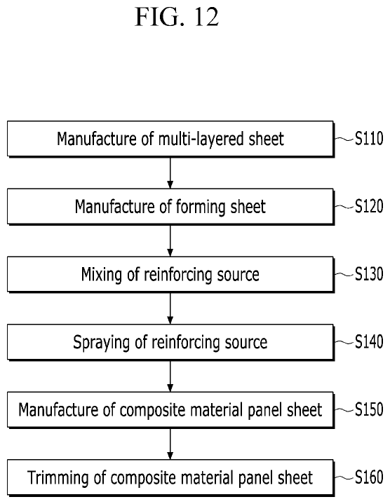

FIG. 12 is a flowchart schematically illustrating a method for molding plastic composite material panels by using a system for molding plastic composite material panels according to an embodiment.

Referring to FIG. 12, a method for molding plastic composite material panels according to an embodiment starts at step S110, and thereafter, step S120 and step S140 are sequentially performed. In addition, step S130 may be selectively performed between the step S120 and the step S140, and step S150 and step S160 may be sequentially performed after performing the step S140.

At the step S110, the multi-layered sheet 21 in which the first resin layer 22, the second resin layer 23, and the third resin layer 24 are laminated is manufactured by the coextrusion unit 20. Here, the coextrusion unit 20 includes the plurality of extrusion portions 25 and the combining adaptor 27.

At the step S110, the plurality of extrusion portions 25 simultaneously extrude the first resin layer 22, the second resin layer 23, and the third resin layer 24, each in a molten state.

At the step S110, the combining adaptor 27 laminates, in the molten state, the first resin layer 22, the second resin layer 23, and the third resin layer 24 simultaneously extruded from respective one of the plurality of extrusion portions 25.

At the step S120, the forming sheet 31 of a preset shape is manufactured by thermoforming the multi-layered sheet 21 by the thermoforming unit 30. Here, the thermoforming unit 30 includes the frame 41, the forming die 42, the forming tool 43, and the air spraying portion 44.

At the step S120, the multi-layered sheet 21 is preheated by a heating chamber (not shown) well-known in the art. An edge portion of the multi-layered sheet 21 is fixed to the frame 41.

At the step S120, the air spraying portion 44 sprays air to the multi-layered sheet 21. Then, the multi-layered sheet 21 is bulged upward by the pressure of air sprayed by the air spraying portion 44.

Here, the forming die 42 includes the plurality of forming sections 46 partitioned by the connection section 45. In addition, in an example, the forming tool 43 includes the forming block 47 of a trapezoid cross-section shape.

At this time, the forming die 42 is in a position lowered downward to be below the multi-layered sheet 21, and the forming block 47 is in a position raised upward to be above the connection section 45.

In such a state, the forming die 42 moves upward, and the forming block 47 moves downward. By this process, the forming block 47 presses the multi-layered sheet 21 while being coupled with the connection section 45 of the forming die 42.

Therefore, at the step S120, the forming connection portion 33 in a shape corresponding to the connection section 45 is formed in the multi-layered sheet 21. Simultaneously, at the step S120, the plurality of panel forming portions 35 in shapes corresponding to the plurality of forming sections 46 are formed in the multi-layered sheet 21.

Thereby, at the step S120, the forming sheet 31 in which the plurality of panel forming portions 35 are integrally connected to each other through the forming connection portion 33 may be formed.

Here, while the preheated multi-layered sheet 21 is bulged upward by the pressure of the air and the forming die 42 has moved upward, the forming block 47 of the trapezoid cross-section shape presses the multi-layered sheet 21 into the connection section 45.

Accordingly, a force applied from a connection region of the connection section 45 and the plurality of forming sections 46 to the multi-layered sheet 21 decreases. Therefore, as shown in FIG. 4, a connection region 37 of the forming connection portion 33 and the plurality of panel forming portions 35 are enabled to have a round shape without a change in thickness, and a change in color due to a change in thickness does not occur.

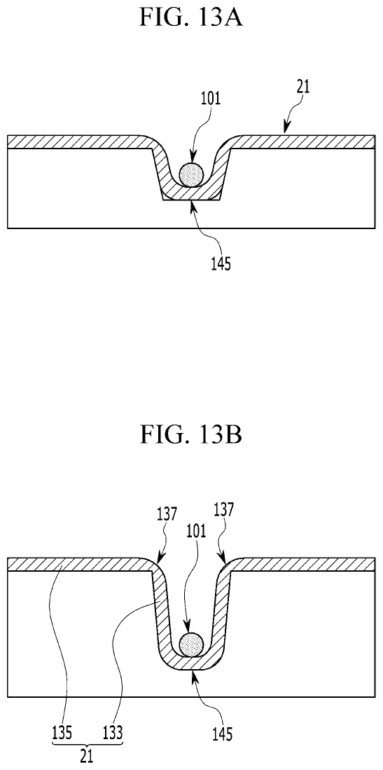

Meanwhile, in a comparison example as shown in FIGS. 13A and 13B, a wire 101 may be used instead of the forming block 47 of the trapezoid cross-section shape. However, in this case, a depth of a connection section 145 needs to be increased in comparison with an embodiment.

This is because, when the depth of the connection section 145 is relatively small, a contact area between the connection section 145 and the multi-layered sheet 21 due to a pressurizing force of the wire 101 is small as shown in FIG. 13A.

In order to prevent such an effect, as shown in FIG. 13B, when the depth of the connection section 145 is relatively large, a force applied to a connection region 137 between a forming connection portion 133 and a plurality of panel forming portions 135 by the pressurizing force of the wire 101 is increased.

Therefore, in such a comparison example, the thickness of the connection region 137 in the round shape is decreased, and thereby a change in color of the connection region 137 may be caused. Furthermore, in the comparison example described above, the increase in the thickness of the connection region 137 may cause an increase of a parting gap between panels and non-uniformity of the parting gap.

On the other hand, at the step S130, the reinforcing source 51 including the fiber material 52 and the polyurethane compound 53 is mixed by the reinforcing source mixing unit 50. Here, the reinforcing source mixing unit 50 includes the mixing main body 54, the first inlet portion 55, the pair of second inlet portions 56, and the discharge portion 57.

At the step S130, the fiber material 52 is input into the interior of the mixing main body 54 through the first inlet portion 55. Simultaneously, at the step S130, the polyurethane compound 53 is input into the interior of the mixing main body 54 through the pair of second inlet portions 56.

Then, the fiber material 52 and the polyurethane compound 53 are mixed by the mixing device (not shown) within the mixing main body 54. The reinforcing source 51 in which the fiber material 52 and the polyurethane compound 53 are mixed as such is discharged through the discharge portion 57. Furthermore, the reinforcing source 51 discharged through the discharge portion 57 is supplied to the reinforcing source spraying unit 60 through the transfer line 61.

At the step S140, the forming sheet 31 formed by the thermoforming unit 30 at the step S120 is transferred to the press-molding unit 70, and the forming sheet 31 is loaded on the upper surface of the lower die 75 that is apart from the upper die 77.

In addition, at the step S140, the reinforcing source 51 is sprayed to the upper surface of the forming sheet 31 by the reinforcing source spraying unit 60. Here, the reinforcing source spraying unit 60 includes the reinforcing source spraying head 65 mounted on the arm of the handling robot 63.

At the step S140, the reinforcing source spraying head 65 is movable in a preset direction by the robot operation of the handling robot 63, and the reinforcing source 51 may be sprayed to the entire region of the upper surface of the forming sheet 31 through the reinforcing source spraying head 65. That is, the reinforcing source spraying head 65 sprays the reinforcing source 51 to an entire region of upper surfaces of the forming connection portion 33 and the plurality of panel forming portions 35 of the forming sheet 31.

At the step S150, the composite material panel sheet 73 is manufactured by press-molding the forming sheet 31 applied with the reinforcing source 51 by the lower die 75 and the upper die 77 of the press-molding unit 70.

Here, the forming sheet 31 applied with the reinforcing source 51 is loaded on the upper surface of the lower die 75 while being fitted with the forming protrusion portion 76 of the lower die 75 through the forming connection portion 33. In addition, the upper die 77 is in a position moved upward relative to the lower die 75.

In such a state, at the step Si50, the upper die 77 is moved downward. Accordingly, as the lower die 75 and the upper die 77 are combined, the composite material panel sheet 73 in which the reinforcing layer 71 is formed on the upper surface of the forming sheet 31 is formed. At this time, the forming connection portion 33 of the forming sheet 31 is fitted with the forming groove portion 78 of the upper die 77.

Thereafter, at the step S150, the upper die 77 is moved upward, and then the composite material panel sheet 73 is taken out from the lower die 75.

Finally, at the step S160, the composite material panel sheet 73 is cut by the trimming unit 80, to manufacture the plurality of plastic composite material panels 10. Here, the trimming unit 80 includes the trimming cutter 81.

At the step S160, the trimming cutter 81 cuts an upper portion of the forming connection portion 33 from the composite material panel sheet 73. Then, as the upper portion of the forming connection portion 33 is cut, the composite material panel sheet 73 is divided into the plurality of cut parts 73a.

Therefore, at the step S160, the plurality of cut parts 73a divided as such may be provided as the plurality of plastic composite material panels 10 according to an embodiment.

Here, each of the plastic composite material panels 10 includes the plate portion 11, the parting portion 13 of a round shape integrally connected to the plate portion 11, and the reinforcing layer 71 formed in the plate portion 11 and the parting portion 13.

The plastic composite material panels 10 according to an embodiment may be assembled to the vehicle body frame 3 of the upper body 1 through a mechanical coupling method and/or a bonding method well-known in the art.

According to the system 100 for molding plastic composite material panels according to an embodiment, the plurality of plastic composite material panels 10 without requiring painting may be simultaneously manufactured by simultaneously molding various panel parts from a single sheet of material.

Therefore, according to an embodiment, it is possible to reduce the investment cost for the molds and the manufacturing cost to mold a plurality of plastic composite material panels 10 to be assembled in the vehicle body, and to reduce the production cycle time.

In addition, according to the system 100 for molding plastic composite material panels according to an embodiment, since the plurality of plastic composite material panels 10 in which the reinforcing layer 71 is formed may be molded, the plurality of plastic composite material panels 10 may have strengthened rigidity and minimized thermal deformation.

Furthermore, the plurality of plastic composite material panels 10 molded by the system 100 for molding plastic composite material panels according to an embodiment includes the parting portion 13 (refer to FIG. 11) formed by the connection region 37 of a round shape as shown in FIG. 4.

Therefore, according to the system 100 for molding plastic composite material panels according to an embodiment, a decrease in thickness of the parting portion 13 and a change in color of the parting portion 13 caused therefrom that may occur during the process of the thermoforming may be prevented. Furthermore, in an embodiment, since the decrease in thickness of the parting portion 13 may be prevented, the parting gap between the plurality of plastic composite material panels 10, which may be adjacent panels to be assembled to the vehicle body, may be decreased, and a uniform parting gap between the plurality of plastic composite material panels 10 may be secured.

Therefore, according to an embodiment, good formability and improved panel quality of the plurality of plastic composite material panels 10 may be secured.

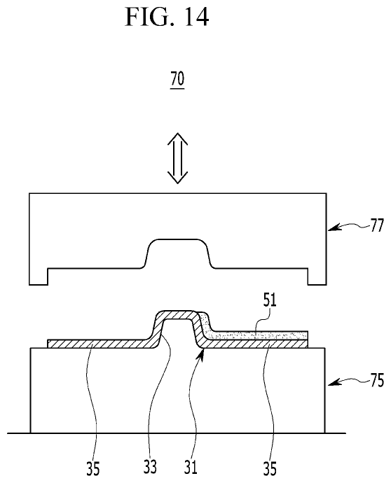

FIG. 14 schematically illustrates another example of a method for molding plastic composite material panels by using a system for molding plastic composite material panels according to an embodiment.

Referring to FIG. 14, according to another example of a method for molding composite material panels according to an embodiment, at the step S140, the reinforcing source 51 is sprayed to a partial region of the upper surface of the forming sheet 31 loaded on the lower die 75 of the press-molding unit 70.

At the step S140, the reinforcing source spraying head 65 of the reinforcing source spraying unit 60 as shown in FIG. 7 sprays the reinforcing source 51 to an upper surface of at least one panel forming portion 35 of the forming sheet 31 by the robot operation of the handling robot 63.

In an example, the reinforcing source spraying head 65 may spray the reinforcing source 51 to the upper surface of the at least one panel forming portion 35, and may not spray the reinforcing source 51 to an upper surface of remaining panel forming portion 35. At this time, the reinforcing source spraying head 65 sprays the reinforcing source 51 to the part of the forming connection portion 33 connected to the at least one panel forming portion 35.

Thereafter, at the step S150, the forming sheet 31 applied with the reinforcing source 51 is press-molded by the lower die 75 and the upper die 77 of the press-molding unit 70.

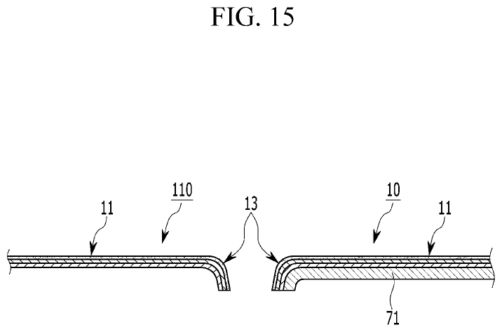

In addition, at the step S160, when the process of cutting the forming connection portion 33 is performed, a plurality of plastic composite material panels 10 and no may be manufactured as shown in FIG. 15.

The at least one plastic composite material panel 10 among the plurality of plastic composite material panels 10 and no includes the plate portion 11, the parting portion 13 of the round shape integrally connected to the plate portion 11, and the reinforcing layer 71 formed on the plate portion 11 and the parting portion 13.

In addition, the remaining plastic composite material panel no among the plurality of plastic composite material panels 10 and no includes the plate portion 11 and the parting portion 13 excluding the reinforcing layer 71.

Therefore, according to another example of a method for molding composite material panels, a plurality of plastic composite material panels 10 and no with and without the reinforcing layer 71 may be simultaneously manufactured by simultaneously molding various panel parts from a single sheet of material.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A system for molding a plurality of plastic composite material panels to be assembled on a vehicle body, the system comprising:
a coextrusion unit configured to manufacture a multi-layered sheet in which a plurality of resin layers are laminated;
a thermoforming unit configured to manufacture a forming sheet having a plurality of panel forming portions partitioned by a forming connection portion by thermoforming the multi-layered sheet;
a reinforcing source spraying unit configured to spray a reinforcing source in which a fiber material and a polyurethane compound are mixed toward a preset region on the forming sheet; and
a press-molding unit configured to press-mold the forming sheet applied with the reinforcing source to manufacture a composite material panel sheet in which a reinforcing layer is formed on the forming sheet.

2. The system of claim 1, further comprising a trimming unit configured to cut the forming connection portion in the composite material panel sheet.

3. The system of claim 2, wherein the trimming unit comprises a trimming cutter configured to cut a part of the forming connection portion.

4. The system of claim 2, wherein a plurality of cut parts remaining by cutting of the forming connection portion from the composite material panel sheet are provided as the plurality of plastic composite material panels.

5. The system of claim 1, further comprising a reinforcing source mixing unit configured to mix the reinforcing source comprising polyol, isocyanate, and the fiber material.

6. The system of claim 5, wherein the fiber material comprises at least one fiber of carbon fiber, glass fiber or aramid fiber.

7. The system of claim 1, wherein the multi-layered sheet comprises:
a first resin layer comprising polymethyl methacrylate (PMMA) resin;
a second resin layer comprising acrylonitrile butadiene styrene (ABS), polycarbonate (PC) or acrylate styrene acrylonitrile (ASA) resin; and
a third resin layer comprising an acrylic resin coated on the first resin layer.

8. The system of claim 1, wherein the coextrusion unit comprises:
a plurality of extrusion portions configured to extrude the plurality of resin layers; and
a combining adaptor configured to laminate the plurality of resin layers extruded from the plurality of extrusion portions.

9. The system of claim 1, wherein the reinforcing source spraying unit comprises a reinforcing source spraying head mounted on an arm of a handling robot and configured to spray the reinforcing source toward the forming sheet loaded on the press-molding unit.

10. The system of claim 9, wherein the reinforcing source spraying head is configured to spray the reinforcing source on an entire region of an upper surface of the forming sheet by a robot operation of the handling robot.

11. The system of claim 9, wherein the reinforcing source spraying head is configured to spray the reinforcing source on at least one panel forming portion excluding at least one remaining panel forming portion of the forming sheet by a robot operation of the handling robot.

12. The system of claim 1, wherein the press-molding unit comprises:
a lower die comprising a forming protrusion portion to be fitted into the forming connection portion in a lower portion of the forming sheet; and
an upper die installed to be vertically movable relative to the lower die and comprising a forming groove portion into which the forming connection portion in an upper portion of the forming sheet is to be fitted.

13. A system for molding a plurality of plastic composite material panels to be assembled on a vehicle body, the system comprising:
a coextrusion unit configured to manufacture a multi-layered sheet in which a plurality of resin layers are laminated;
a thermoforming unit configured to manufacture a forming sheet having a plurality of panel forming portions partitioned by a forming connection portion by thermoforming the multi-layered sheet, the thermoforming unit comprising:
a forming die provided on a frame to be vertically movable and having a plurality of forming sections partitioned by a connection section in a groove shape; and
a forming tool provided on the frame to be vertically movable and configured to pressurize the multi-layered sheet toward the connection section;
a reinforcing source spraying unit configured to spray a reinforcing source in which a fiber material and a polyurethane compound are mixed toward a preset region on the forming sheet; and
a press-molding unit configured to press-mold the forming sheet applied with the reinforcing source to manufacture a composite material panel sheet in which a reinforcing layer is formed on the forming sheet.

14. The system of claim 13, wherein the thermoforming unit further comprises an air spraying portion configured to spray air to the multi-layered sheet and having an edge portion fixed to the frame.

15. The system of claim 13, wherein the forming tool comprises a forming block in a trapezoidal shape configured to be inserted into the connection section.

16. A method for molding a plurality of plastic composite material panels to be assembled on a vehicle body, the method comprising:
manufacturing a multi-layered sheet in which a plurality of resin layers are laminated;
manufacturing a forming sheet having a plurality of panel forming portions partitioned by a forming connection portion by thermoforming the multi-layered sheet;
spraying a reinforcing source comprising a mix of a fiber material and a polyurethane compound toward a preset region on the forming sheet; and
press-molding the forming sheet applied with the reinforcing source to manufacture a composite material panel sheet having a reinforcing layer formed on the forming sheet.

17. The method of claim 16, further comprising cutting the forming connection portion in the composite material panel sheet.

18. The method of claim 17, wherein cutting the forming connection portion comprises using a trimming cutter to cut a part of the forming connection portion.

19. The method of claim 16, wherein the fiber material comprises at least one fiber of carbon fiber, glass fiber or aramid fiber.

20. The method of claim 16, wherein the multi-layered sheet comprises:
a first resin layer comprising polymethyl methacrylate (PMMA) resin;
a second resin layer comprising acrylonitrile butadiene styrene (ABS), polycarbonate (PC) or acrylate styrene acrylonitrile (ASA) resin; and
a third resin layer comprising an acrylic resin coated on the first resin layer.
